(19) United States
(12) Patent Application Publication
(10) Pub. No.: US 2011/0235927 A1
(43) Pub. Date: Sep. 29, 2011

(54) IMAGE PROCESSING APPARATUS AND METHOD

(75) Inventor: Toru Ushiku, Tokyo (JP)

(73) Assignee: CANON KABUSHIKI KAISHA, Tokyo (JP)

(21) Appl. No.: 13/051,141

(22) Filed: Mar. 18, 2011

(30) Foreign Application Priority Data
Mar. 23, 2010 (JP) 2010-066345

(51) Int. Cl. G06K 9/36

(52) U.S. Cl. 382/232

(57) ABSTRACT

The image processing apparatus of the present invention comprises: an rendering unit for, when image data that includes two or more objects is inputted, rendering the two or more objects as bitmap data; a generation unit for generating attribute information for the image data based on the rendered bitmap data and attributes of the objects; a storing unit for storing the rendered bitmap data or bitmap data by operating logical rendering for the bitmap data based on the attribute information that was generated by the generation unit in a storage having two or more layers; and a compression unit for, using a different compression method for each of the two layers or more, compressing each of the rendered bitmap data.

### BACKGROUND OF THE INVENTION

1. Field of the Invention

The present invention relates to an image processing apparatus and image processing method that receives PDL data, renders that data and forms an image.

2. Description of the Related Art

Generally, the file size of a color image is large, so that technology is needed that reduces the file size of a color image while maintaining the image quality as much as possible. For example, there is image processing technology that is being performed that reduces the file size without much decrease in the image quality of the processed image, and even when there are areas that have special attributes such as text or graphics in the processed image, maintains the visual quality of the image having those special attributes (for example, refer to Japanese Patent Laid-Open No. 2005-204206). In Japanese Patent Laid-Open No. 2005-204206, an inputted multi-valued image and binary image based on that inputted multi-valued image are prepared, and based on the binary image, pixels of areas having specified attributes such as areas of text are identified. Next, depending on whether or not there are specified attribute areas, a binary image is generated that replaces the pixels that do not have specified attributes with white pixels, and an image of the specified attribute sections is generated using a set color, as well as a multi-value image, in which the pixels that have specified attributes are filled in with the background color, is generated, and all of the images are encoded. In Japanese Patent Laid-Open No. 2005-204206 above, even when there are areas that have specified attributes such as text and lines, it is possible to reduce the file size while maintaining the visual quality of an image having specified attribute sections and without much of a decrease in the image quality of the multi-value images that do not have specified attributes.

However, in Japanese Patent Laid-Open No. 2005-204206, a binary image is generated when specified attribute sections such as text areas are detected, so that there is a possibility that the quality of text images will deteriorate. Furthermore, pixels other than those of text areas are converted to white pixels, so that when a multi-value image is compressed there is a possibility that the quality of the multi-value image will deteriorate.

### SUMMARY OF THE INVENTION

In order to achieve the object above, the image processing apparatus of the present invention comprises: a rendering unit for, when image data that includes two or more objects is inputted, rendering the two or more objects as bitmap data; a generation unit for generating attribute information for the image data based on the rendered bitmap data and attributes of the objects; a storing unit for storing the rendered bitmap data or bitmap data by operating logical rendering for the bitmap data based on the attribute information that was generated by the generation unit in a storage having two or more layers; and a compression unit for, using a different compression method for each of the two layers or more, compressing each of the rendered bitmap data.

Further features of the present invention will become apparent from the following description of exemplary embodiments (with reference to the attached drawings).

### BRIEF DESCRIPTION OF THE DRAWINGS

FIG. 1 is a diagram illustrating the system configuration of an embodiment of the present invention;

FIG. 2 is a diagram illustrating the block construction of an embodiment of the present invention;

FIG. 3 is a diagram illustrating the PDL processing flow of an embodiment of the present invention;

FIG. 4 is a diagram illustrating the print processing flow of an embodiment of the present invention;

FIG. 5 is a diagram illustrating the rendering output configuration of an embodiment of the present invention;

FIG. 6 is a diagram illustrating the processing flow of the rendering output process of an embodiment of the present invention;

FIG. 7 is a diagram illustrating the processing flow of the layer selection process of an embodiment of the present invention;

FIGS. 8A and 8B are diagrams illustrating a detailed example of rendering output of an embodiment of the present invention;

FIG. 9 is a diagram illustrating the compression process configuration of an embodiment of the present invention;

FIG. 10 is a diagram illustrating the decompression process configuration of an embodiment of the present invention;

FIG. 11 is a diagram illustrating a layer selection table of an embodiment of the present invention; and

FIG. 12 is a diagram illustrating the processing flow of the buffer arranging process of an embodiment of the present invention.

### DESCRIPTION OF THE EMBODIMENTS

In the following, preferred embodiments of the present invention are explained with reference to the drawings.

### Embodiment 1

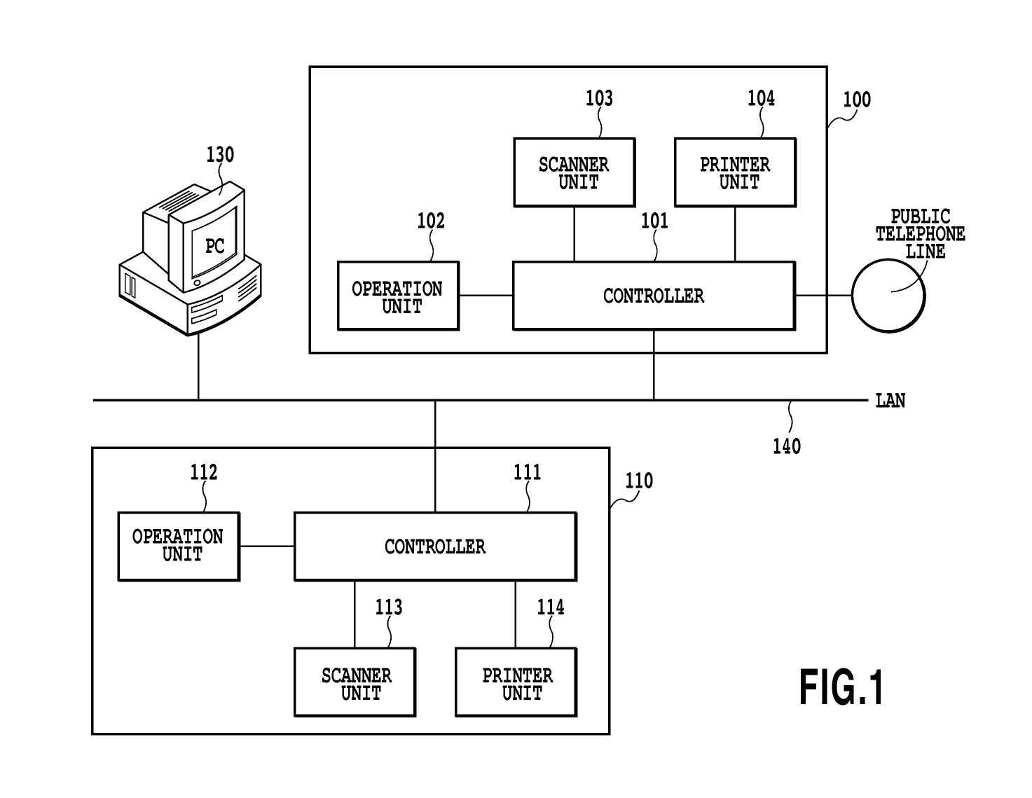

FIG. 1 is a block diagram illustrating the configuration of an image processing system of an embodiment the present invention. In this system, a host computer 130 and two image processing devices 100 and 110 are connected to an LAN 140; however, even though in this embodiment an LAN is used as the method of connection, the present invention is not limited to this. For example, an arbitrary network such as a WAN (public lines), a serial transmission method such as USB, or parallel transmission method such as Centronix or SCSI can also be used.

Any computer having the basic functions as a personal computer can be used as the host computer (hereafter, referred to as the PC) 130. The PC 130 uses FTP and SMB protocol via a network such as an LAN 140 or WAN, and is capable of transmitting and receiving files and transmitting and receiving e-mail. Furthermore, the PC 130 can instruct the image processing devices 100, 110 via a printer driver to print. The image processing devices 100 and 110 basically have the same construction, and have a scanner unit. In order to simplify the explanation below, the construction of the image processing devices 100, 110 will be explained in detail using the image processing device 110.

The image processing device 110 comprises a scanner unit 113 that functions as an image input device, a printer unit 114 that functions as an image output device, a controller 111 that performs overall control of the image processing device 110, and an operation unit 112 that functions as a user interface (UI).

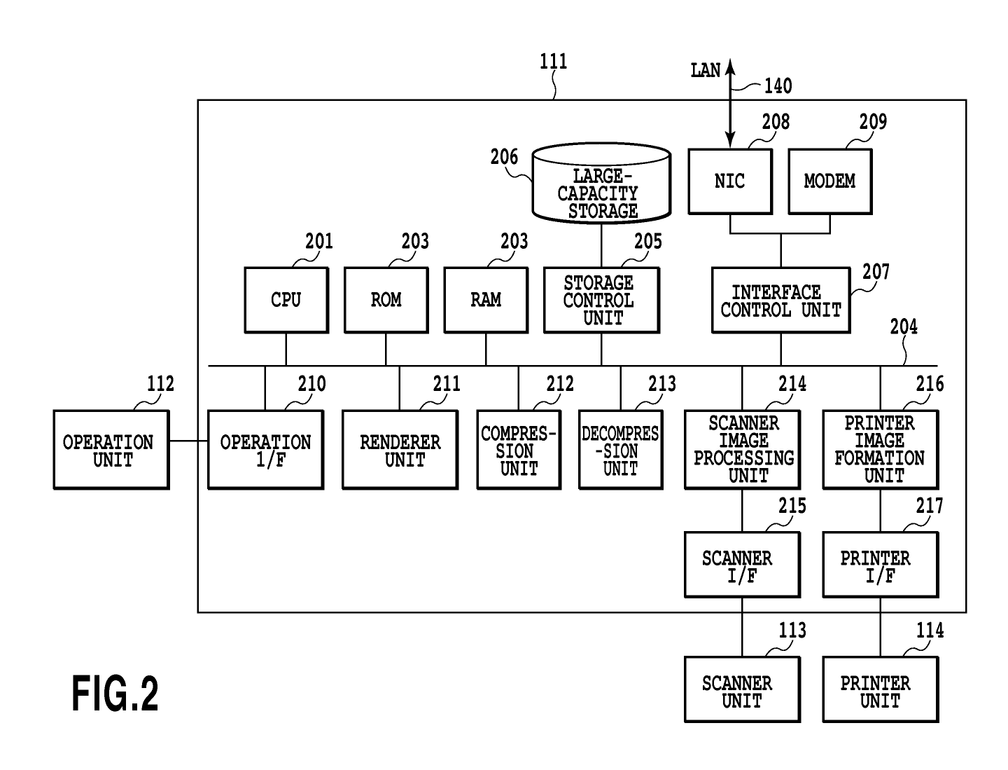

FIG. 2 is a block diagram illustrating the construction of the controller of this embodiment. A CPU 201 functions as the controller for performing overall control of the image processing device 110. The CPU 201 activates the OS (Operating System) by way of a boot program that is stored in ROM 202. The CPU 201 causes the OS to execute a controller program and various application programs that are stored in a large-capacity storage 206. The CPU 201 is connected to all of the units by an internal bus such as a data bus 204.

A RAM 203 is used as a temporary memory area for the main memory or work area of the CPU 201, and is further used as a temporary memory area for image processing. An interface control unit 207 controls the network I/F such as a NIC (Network Interface Card) 208, and transmits and receives various kinds of data such as image data over a network such as an LAN. The interface control unit 207 also controls a modem 209, and transmits and receives data using a telephone line.

An operation I/F 210 receives input such as a user's operation instructions from the operation unit 112 that comprises a touch panel and/or keyboard. Similarly, the operation I/F 210 controls the operation unit 112 that comprises a LCD, CRT and the like, and displays operation screens for the user. A renderer unit 211 generates bitmap data that can be processed by the printer unit 114 based on data received via the interface control unit 207. A compression unit 212 performs compression of the bitmap data. A decompression unit 213 decompresses the data that was compressed by the compression unit 212 and outputs bitmap data.

A scanner image processing unit 214 performs correction, processing and editing of images read by the scanner unit 113 and received via a scanner I/F 215. The scanner image processing unit 214 determines whether the received image data is a color document or black and white document, or whether it is a text document or a photograph document. That judgment result is correlated with the image data, and such correlated information is called attribute data. A printer image formation unit 216 performs image processing for printing by the printer unit, and transmits the result as bitmap data to the printer unit 114 via a printer I/F 217.

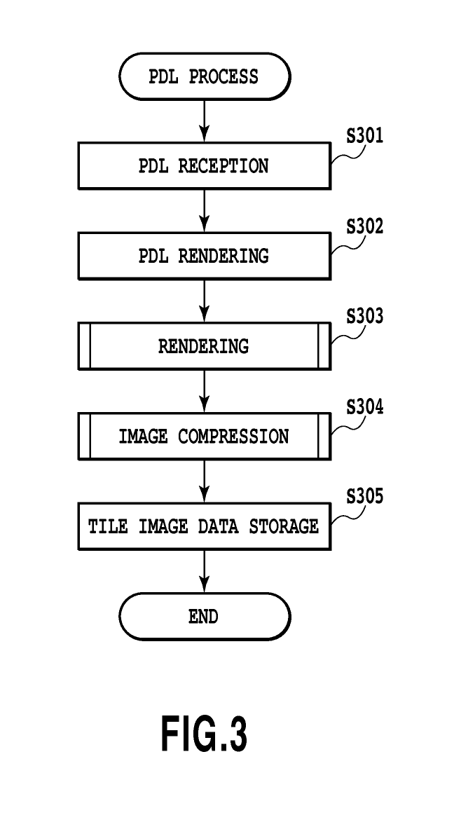

FIG. 3 is a diagram illustrating the PDL (Page Description Language) processing flow by the controller 111 of this first embodiment of the present invention.

Referring to FIG. 3, first, the interface control unit 207 of the controller 111 receives PL data from the host computer 130 that is connected to the LAN 140, and temporarily stores the received PDL data in RAM 203 or the large-capacity storage 206 (S301). The CPU 201 of the controller 111 renders the PDL data that was acquired in S301 and generates a display list (S302).

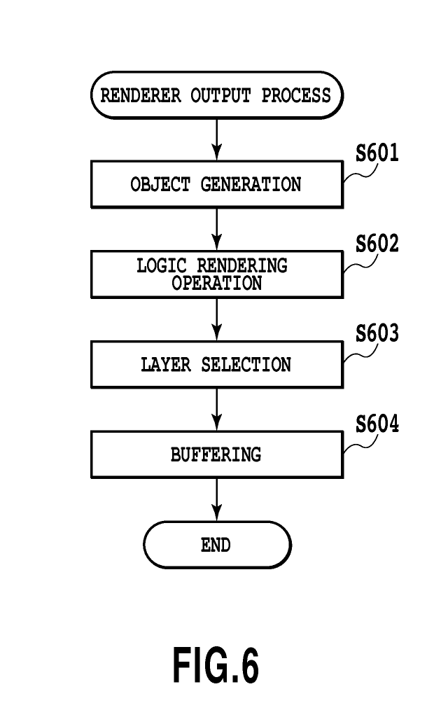

The renderer unit 211 of the controller 111 renders the display list that was generated in S302, and generates bitmap data that corresponds to the rendered PDL data in preset block units (for example, 64 pixels×64 pixels) (S303). Step S303 will be described in detail later with reference to FIG. 6. In the explanation of this embodiment, this bitmap data that has been divided in block units is called tile data, and the unit of transmission data that is a combination of the header information of the tile image data, and various information about the image data and attribute data is called packet data.

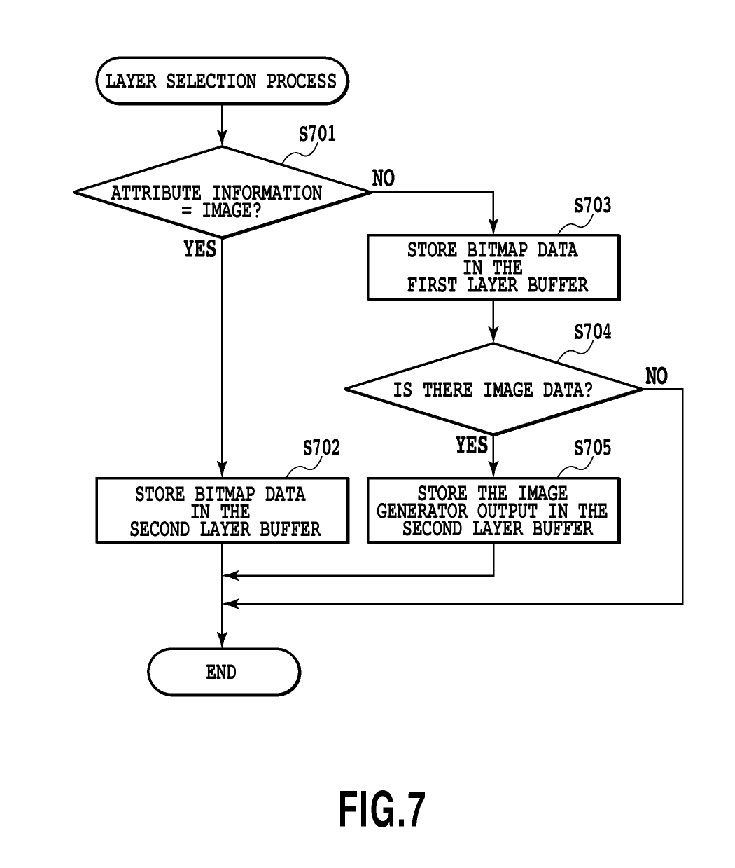

The compression unit 212 of the controller 111 executes resolution conversion of the bitmap data generated in S303, and generates bitmap data that is compressed in block units (S304). Step S304 will be described in detail later with reference to FIG. 7. The controller 111 stores the compressed bitmap data that was generated in S304 in RAM 203 or the large-capacity storage 206 (S305).

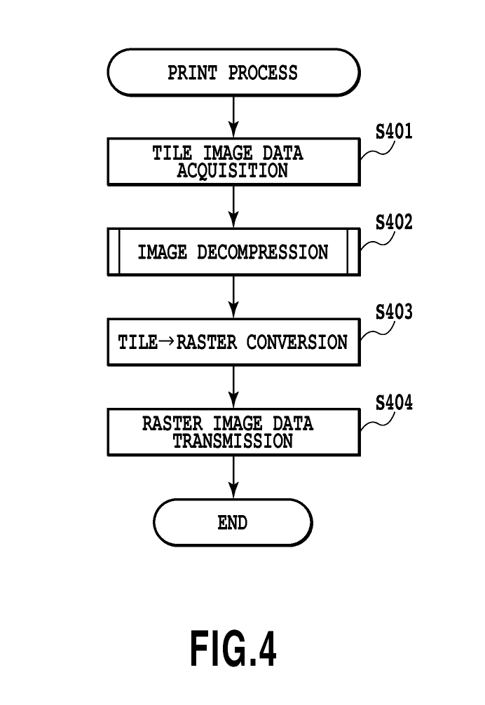

FIG. 4 is a diagram illustrating the print processing flow by the controller 111 in this first embodiment of the present invention.

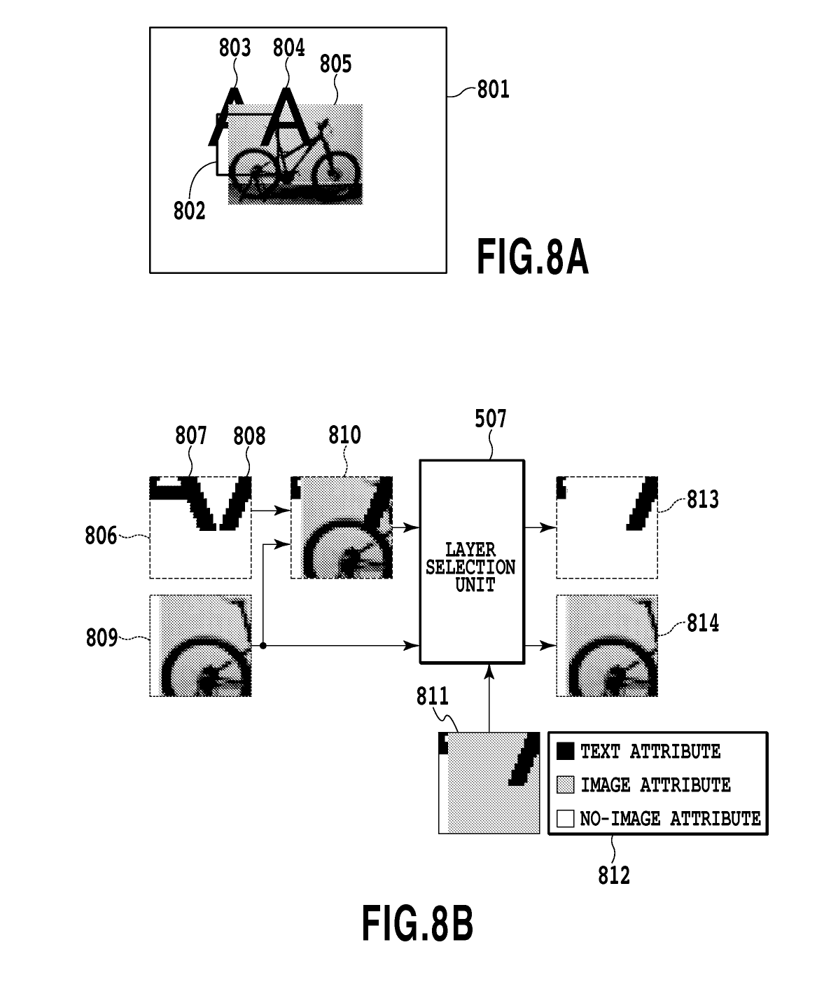

Referring to FIG. 4, first, the controller 111 reads the compressed bitmap data that was stored in S305 from the RAM 203 or large-capacity storage 206 (S401). The decompression unit 213 of the controller 111 decompresses the compressed bitmap data that was acquired in S401, and generates decompressed bitmap data in block units (S402). Step S402 is described in detail later with reference to FIGS. 8A and 8B. The CPU 201 of the controller 111 renders the bitmap data that was decompressed in S402 in a buffer memory, and generates bitmap data in page units from the bitmap data in block units, then stores that data in RAM 203 (S403). A printer image formation unit 216 of the controller 111 performs image processing for using the bitmap data in page units that was generated in S403 by the printer unit, and transmits that data to the printer unit 214 via the printer I/F 217 (S404).

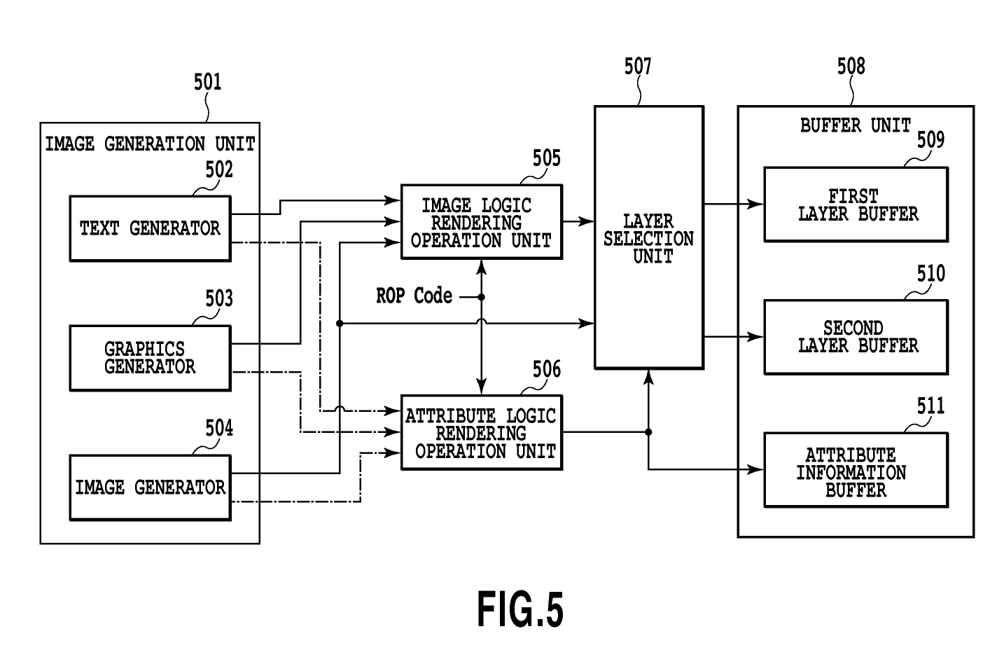

FIG. 5 is a block diagram illustrating the details of the renderer unit 211 of this first embodiment of the present invention.

In an image generation unit 501, image generation is performed based on the display list that was generated in S302. In this embodiment, the image generation unit 501 comprises a text generator 502, graphics generator 503 and image generator 504. The text generator 502 generates bitmap data of a text object that is included in the display list. The graphics generator 503 generates bitmap data of a graphics object that is included in the display list. The image generator 504 generates bitmap data of an image object that is included in the display list.

An image logic rendering operation unit 505 performs image generation by a logic rendering operation that uses ROP (Raster Operation) code that is included in the display list. Similar to the image logic rendering operation unit 505, an image logic rendering operation unit 506 generates attribute information in pixel units by performing a logic rendering operation on attribute information of each object based on ROP (Raster Operation) code that is included in the display list. One logic rendering operation is a method of overwriting in which attribute information of a lower object is written over by attribute information of an object that is to be located on top.

In an image, a text area is assigned a text attribute, an image (photo) area is assigned an image attribute, and for a graphics area, a bitmap that is assigned a graphics attribute becomes the attribute information. In FIG. 8B that will be described later, 811 is an example of attribute information. A layer selection unit 507 selects an output layer buffer based on attribute information generated by the attribute logic rendering operation unit 506. The method of selection is described in detail later with reference to FIG. 6.

A buffer unit 508 comprises a first layer buffer 509, a second layer buffer 510 and attribute information buffer 511. The first layer buffer 509 is a buffer for storing text and graphics bitmap data. The second layer buffer 510 is a buffer for storing image bitmap data. The attribute information buffer 511 is a buffer for storing attribute information.

FIG. 6 is a diagram illustrating the processing flow of rendering output, and illustrates in detail the processing flow of S303 illustrated in FIG. 3.

Referring to FIG. 6, first, the renderer unit 211 generates a rendering object based on the display list (S601). When doing this, the renderer unit 211 generates bitmap data for each kind of rendering object by way of the text generator 502, graphics generator 503 and image generator 504.

Next, the renderer unit 211 performs a logic rendering operation based on the display list and the data generated in S601 (S602). Here, a logic rendering operation is performed for bitmap data and attribute information. The renderer unit 211 selects a layer for storing the generated bitmap data based on the results of the attribute logic rendering operation unit 506 (S603). The renderer unit 211 stores bitmap data in the layer buffer that was selected in S603 (S604).

FIG. 7 is a diagram illustrating the processing flow of the layer selection unit 507 of this embodiment.

Referring to FIG. 7, first, the layer selection unit 507, based on the result of the attribute logic rendering operation unit 506, and according to the attribute information of the block that is the object of processing, determines whether or not that block only has an image attribute (S701). When the judgment result in S701 is (YES), the layer selection unit 507 stores the bitmap data of the operation result of the image logic rendering operation unit 505 in the second layer buffer 501 (S702). When the judgment result in S701 is (NO), or in other words, when a text attribute or graphics attribute is included in that block, the layer selection unit 507 stores the bitmap image of the operation result of the image logic rendering operation unit 505 that corresponds to the text attribute or graphics attribute information in the first layer buffer 509 (S703).

Next, the layer selection unit 507 determines whether or not there is bitmap data generated by the image generator 504 (S704) in the block that is the object of processing. When the judgment result of S704 is (YES), the layer selection unit 507 stores bitmap image data generated by the image generator 504 in the second layer buffer 510 (S705).

FIGS. 8A and 8B are diagrams for explaining a detailed example of the processing flow of the rendering output of this embodiment explained with reference to FIG. 6. Referring to FIG. 8A, the printed image 801 is comprised of two letters “A” 803 and 804 as examples of text objects, and an image object 805. The renderer unit 211 performs processing in block units, so that an example of rendering block data 802 of the printed image 801 is explained.

The text generator 502 generates bitmap data 806 by rendering the text objects “A” 803 and 804 in block units. The bitmap data 806 comprises bitmap data 807 and 808 that is rendered from part of the text objects “A” 803 and 804. The image generator 504 generates bitmap data 809 by rendering image object 805 in block units.

The image logic rendering operation unit 505 generates block bitmap data 810 by a logic rendering operation based on bitmap data 806 and 809. The layer selection unit 507 references the attribute information 811, and because a black part of the bitmap data 813 is a part of text attribute and is not a part of image attribute, stores the bitmap data 813 in the first layer buffer 509. Furthermore, because there is image attribute in block 802 as the bitmap data 811, the layer selection unit stores bitmap data 809 in the second layer buffer 510. For the attribute information type 812 in the attribute data 811, black indicates a text attribute, gray indicates an image attribute and white indicates that there is no image.

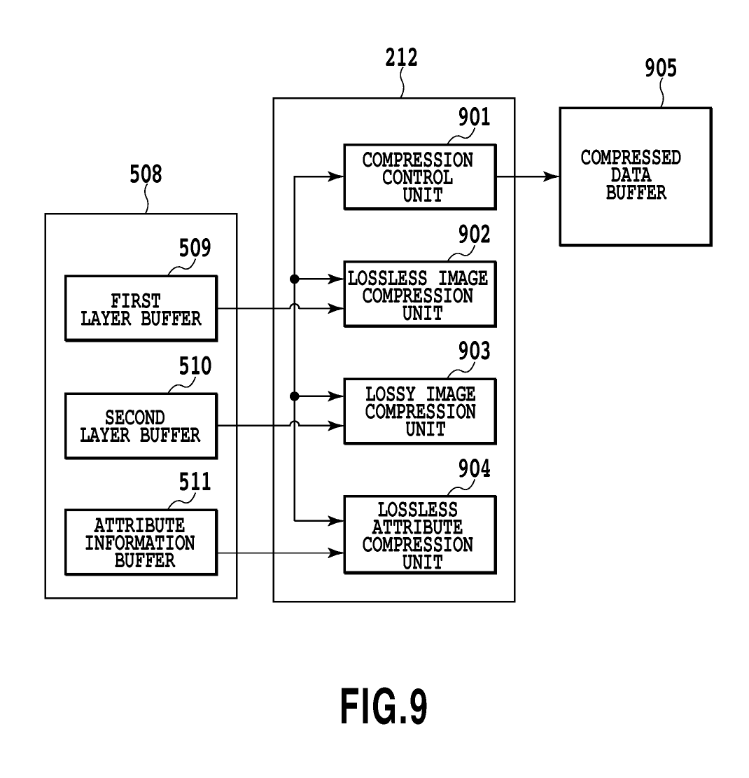

FIG. 9 is a diagram for explaining processing by the compression unit 212 that is suitable for this embodiment of the present invention. A compression control unit 901 performs overall control of the compression process. The compression control unit 901 reads bitmap data from the buffer unit 508, and performs control of the compression process by way of a lossless image compression unit 902, a lossy image compression unit 903 and a lossless attribute compression unit 904, and stores the compressed data in the compressed data buffer 905.

The lossless image compression unit 902 reads the text and graphics bitmap data from the first layer buffer 509 of the buffer unit 508, and performs lossless compression of that data. The lossy image compression unit 903 reads the image bitmap data from the second layer buffer 510 of the buffer unit 508, and performs lossy compression of that data. The lossless attribute compression unit 904 reads attribute information from the attribute information buffer 511 of the buffer unit 508, and performs lossless compression of that information.

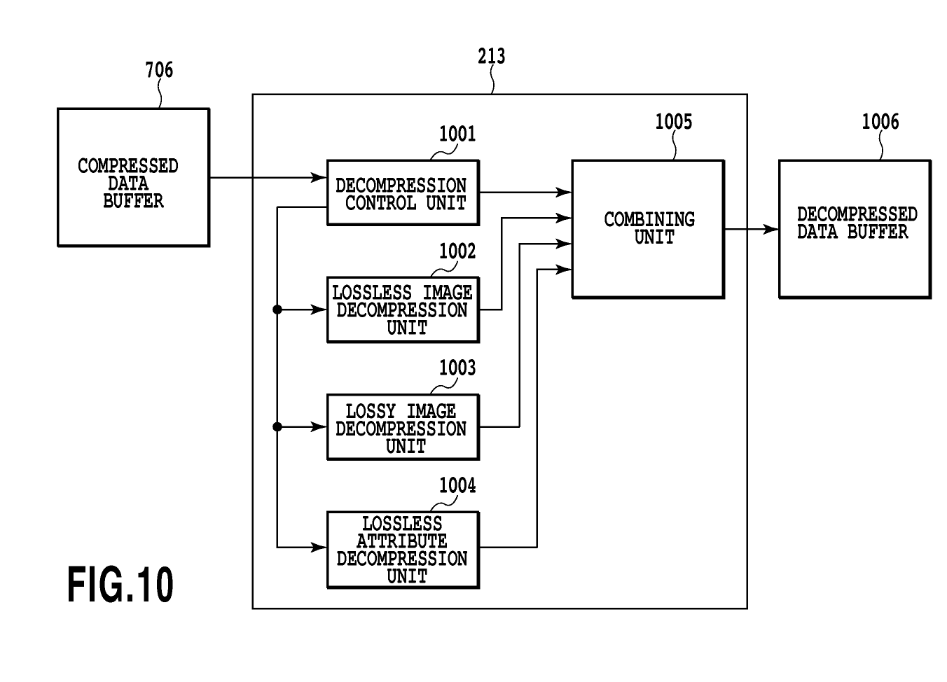

FIG. 10 is a diagram for explaining the processing by the decompression unit 213 that is suitable for this embodiment of the present invention. The decompression unit 1001 performs overall control of the decompression process. The decompression unit 1001 reads compressed data from the compressed data buffer 905, performs control of the decompression process by way of a lossless image decompression unit 1002, lossy image decompression unit 1003 and lossless attribute decompression unit 1004, and output the result to a combining unit 1005.

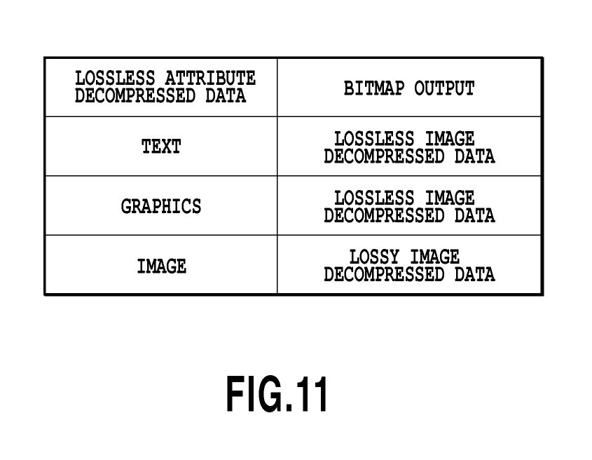

The lossless image decompression unit 1002 decompresses compressed data that is inputted from the decompression control unit 1001, and outputs the result to the combining unit 1005. The lossy image decompression unit 1003 decompressed compressed data that is inputted from decompression control unit 1001, and outputs the result to the combining unit 1005. The lossless attribute decompression unit 1004 decompresses compressed data that is inputted from the decompression control unit 1001, and outputs the result to the combining unit 1005. The combining unit 1005 performs a process of combining the outputted data from the lossless image decompression unit 102, the lossy image decompression unit 1003 and the lossless attribute decompression unit 1004, and generates bitmap data. The combining process will be described in detail later with reference to FIG. 11. The combining unit 1005 outputs the generated bitmap data and the data generated by the lossless attribute decompression unit 1004 to the decompressed data buffer 1006.

FIG. 11 is a diagram illustrating a combining table that is used by the combining unit 1005 of this embodiment.

The combining unit 1005 generates bitmap data based on the output results from the lossless attribute decompression unit 1004. When the output of the lossless attribute decompression unit 1004 indicates a text or graphics attribute, the combining unit 1005 generates the output data from the lossless image decompression unit 1002 as bitmap data. When the output from the lossless attribute decompression unit 1004 indicates an image attribute, the combining unit 1005 generates the output data from the lossy image decompression unit 1003 as bitmap data. Lossless compression of a part of text and graphics can provides high quality in the part of text and graphics of image.

With the first embodiment described above, even when there is an area having a specified attribute such as text or graphics, it is possible to maintain the visual quality of the image having the specified attribute, as well as reduce the file size without further reducing the image quality of the image.

### Embodiment 2

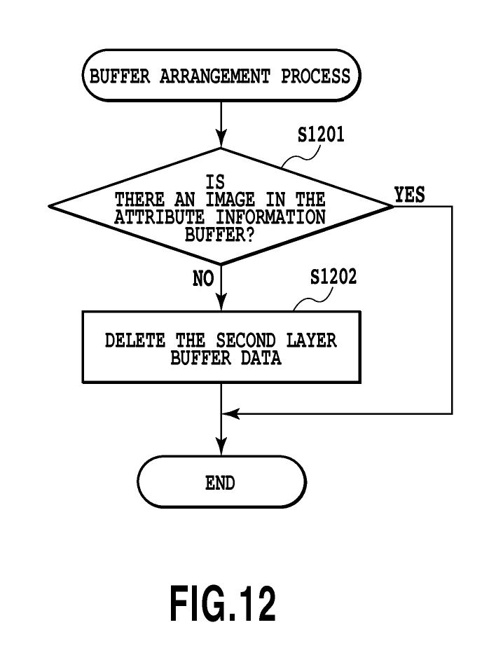

A second embodiment of the present invention arranges the data stored in the buffer unit 508 before performing the compression process of step S304 in the first embodiment. FIG. 12 is a diagram illustrating the processing flow of a process to arrange data of this embodiment that is performed before the compression process of step S304.

The controller 111 determines whether or not of the data generated in step S303 there is an image attribute in the data stored in the attribute information buffer 511 (S1201). When the result of judgment in S1201 is (NO), the controller 111 deletes the bitmap data that is stored in the second layer buffer 510 (S1202).

With this second embodiment described above, in processing in block units, it is possible to reduce the file size without a decrease in image quality.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-066345, filed Mar. 23, 2010, which is hereby incorporated by reference herein in its entirety.

What is claimed is:

1. An image processing apparatus comprising:
a rendering unit for, when image data that includes two or more objects is inputted, rendering the two or more objects as bitmap data;
a generation unit for generating attribute information for the image data by operating logical rendering for attributes of the objects;
a storing unit for storing the rendered bitmap data or bitmap data by operating logical rendering for the bitmap data based on the attribute information that was generated by the generation unit in a storage having two or more layers; and
a compression unit for, using a different compression method for each of the two layers or more, compressing each of the rendered bitmap data.

2. The image processing apparatus according to claim 1, wherein
the image data is PDL data, and
one of the layers of the storage stores bitmap data of an image object rendered from the PDL data.

3. The image processing apparatus according to claim 1, wherein
the storing unit stores the bitmap data based on attribute information so that text and graphics objects and image objects are stored in different layers.

4. The image processing apparatus according to claim 1, wherein
the different compression methods for each layer include lossless compression and lossy compression.

5. The image processing apparatus according to claim 1, wherein
data stored in part of the layers of the storage is deleted according to the attribute information before processing by the compression unit.

6. An image processing method comprising:
a rendering step for, when image data that includes two or more objects is inputted, rendering the two or more objects as bitmap data;
a generation step for generating attribute information for the image data by operating logical rendering for attributes of the objects;
a storing step for storing the rendered bitmap data or bitmap data by operating logical rendering for the bitmap data based on the attribute information that was generated by the generation step in a storage having two or more layers; and
a compression step for, using a different compression method for each of the two layers or more, compressing each of the rendered bitmap data.
